(19) United States
(12) Patent Application Publication
(10) Pub. No.: US 2010/0022118 A1
(43) Pub. Date: Jan. 28, 2010

(54) POWER CONNECTOR HAVING AN IMPORVED INTERNAL PRINTED CIRCUIT BOARD

(75) Inventors: DE-GANG ZHANG, Kunshan (CN); PING-SHENG SU, Tu-Cheng (TW); YI ZHOU, Shenzhen (CN); XUE-NIAN WANG, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/508,786

(22) Filed: Jul. 24, 2009

(30) Foreign Application Priority Data
Jul. 24, 2008 (CN) 200820039114.7

(51) Int. Cl. H01R 24/04; H01R 3/00

(52) U.S. Cl. 439/490; 439/669

(57) ABSTRACT

A power connector (100) has a mating plug (10) having a number of contacts (110), an internal printed circuit board (30) mounted to the mating plug and located in one transverse direction perpendicular to the pluggable direction, a cable (20) connected to the internal circuit board, and outer barrel (50) enclosing the mating plug and the cable. The internal printed circuit board defines a conductive area (31). The cable provides a connecting section (24) connecting with the conductive area of the internal printed circuit board and extending through the internal printed circuit board to connect with the contact of the mating plug.

### BACKGROUND OF THE INVENTION

1. Field of the Invention

The present invention relates generally to a power connector, and more particularly to a power connector with an internal printed circuit board for electrically connecting a cable to a mating plug.

2. Description of the Prior Art

Direct current (DC) power connector has been widely used in electrical device to be connected to DC power connector to transmit direct current power. U.S. Pat. No. 6,572,402 issued to Lin discloses an electrical connector assembly having an internal printed circuit board, a plurality of cables soldered to the internal printed circuit board, a mating plug having a plurality of wires soldered to the internal printed circuit board in order to electrically connect with the cables. However, it is difficult to sold the number of cables and the wires to a small internal printed circuit board.

Hence, in this art, a power connector to overcome the above-mentioned disadvantages of the prior art should be provided.

### BRIEF SUMMARY OF THE INVENTION

A primary object, therefore, of the present invention is to provide a power connector with an improved internal printed circuit board for easily connecting cables to a mating plug.

In order to implement the above object, a power connector mateable with a complementary connector comprises a mating plug having a plurality of contacts, an internal printed circuit board mounted to the mating plug and located in one transverse direction perpendicular to the pluggable direction and a cable connected to the internal circuit board. The internal printed circuit board defines a conductive area. The cable provides a connecting section to connect with the conductive area of the internal printed circuit board and extending through the internal printed circuit board to connect with the contacts of the mating plug.

It is easy to connect the cable to the mating plug by the conductive area disposed on the internal printed circuit board.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an assembled perspective view illustrating a power connector in accordance with a preferred embodiment of the present invention;

FIG. 2 is a partially exploded perspective view of the power connector, with a guiding pipe enclosing a cable;

FIG. 3 is an exploded perspective view of a mating plug;

FIG. 4 is an exploded perspective view of the power connector as shown in FIG. 2; and

FIG. 5 is a perspective view of the mating plug and a cable connected to the mating plug; and

FIG. 6 is a perspective view of the mating plug and the cable, taken from another aspect.

### DETAILED DESCRIPTION OF THE INVENTION

Reference will now be made in detail to a preferred embodiment of the present invention.

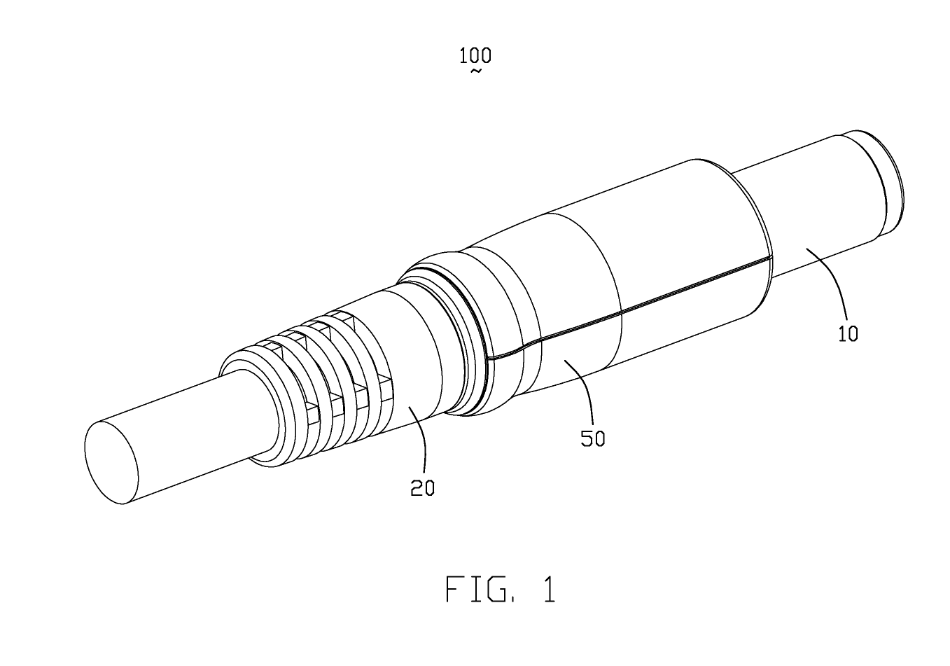

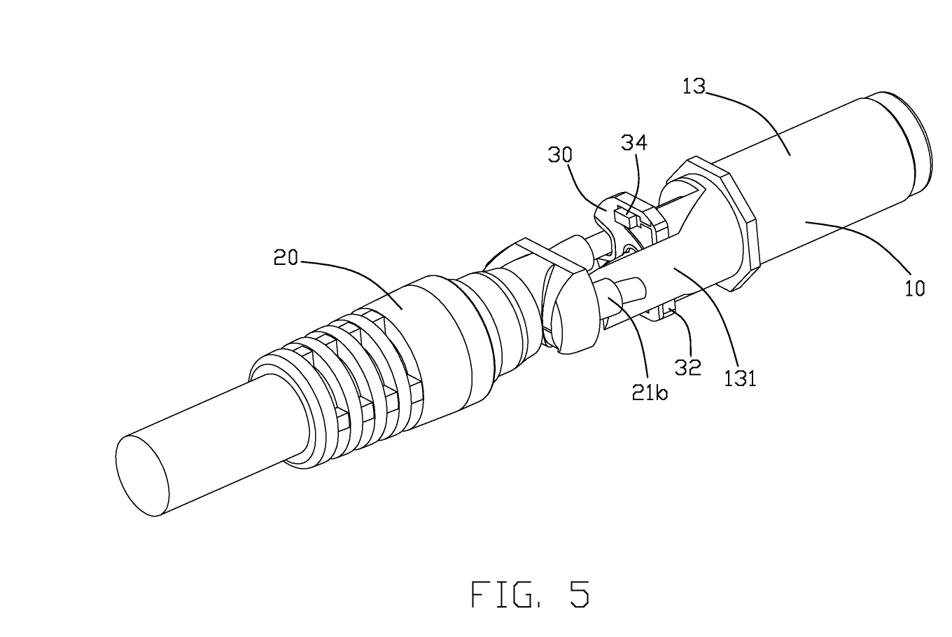

Reference to FIGS. 1-5, a power connector made in accordance with a preferred embodiment of the present invention is shown. The power connector 100 is mateable with a complementary connector (not shown) in a pluggable direction comprises a mating plug 10, a cable 20 having a connecting section 24 electrically connecting with the mating plug 10, and a guiding pipe 40 and an outer barrel 50 partially enclosing the mating plug 10.

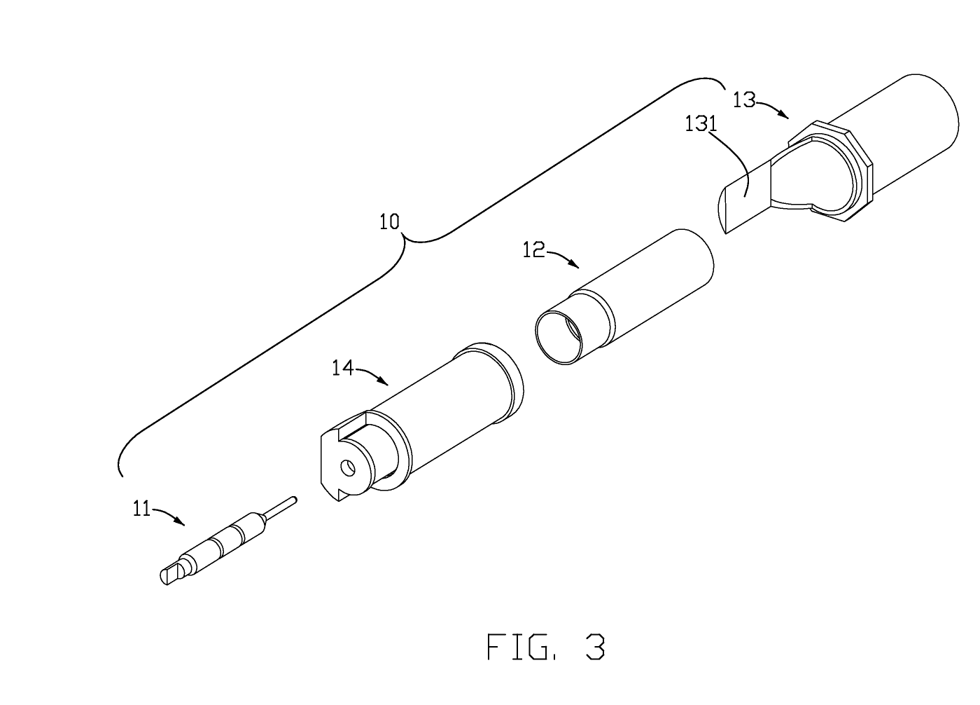

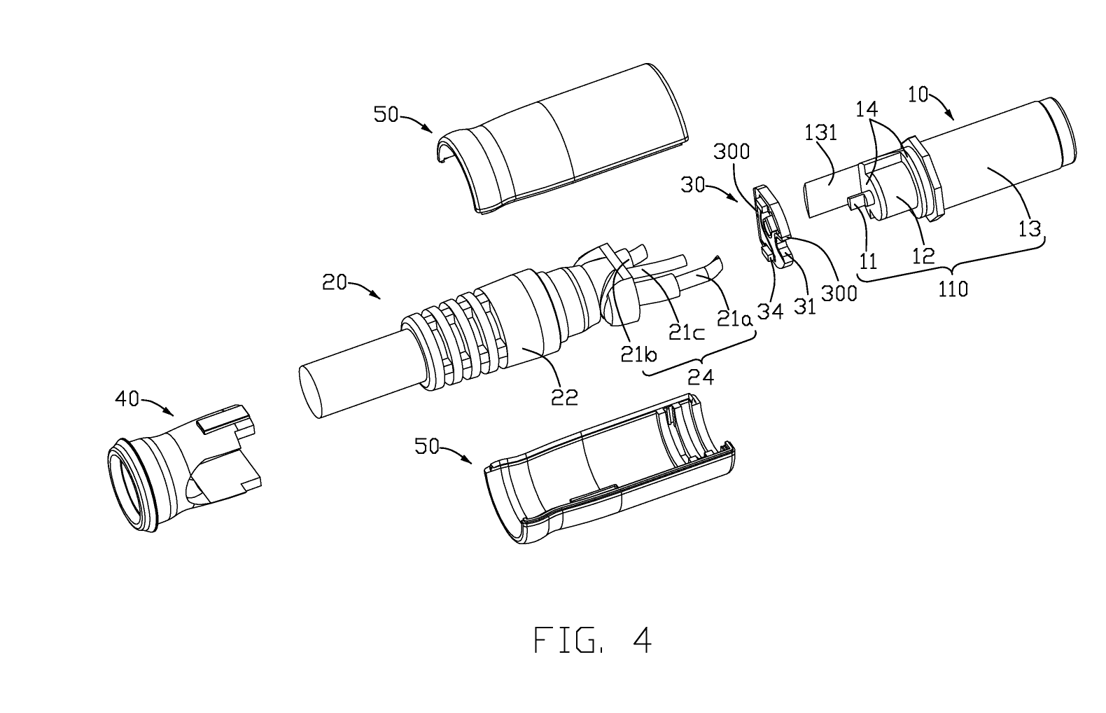

Reference to FIGS. 3 and 4, the mating plug 10 has a plurality of contacts 110 including a central pin 11, an outer conductor 13 and a first terminal 12. The matting plug 10 has an insulator 14 enclosing the central pin 11. The first terminal 12 is retained into the insulator 14 for transmitting anode power. The outer conductor 13 encloses the insulator 14 for transmitting cathode power. The insulator 14 is located between the outer conductor 13 and the first terminal 12. The outer conductor 13 has a protruding end 131 extending forwardly.

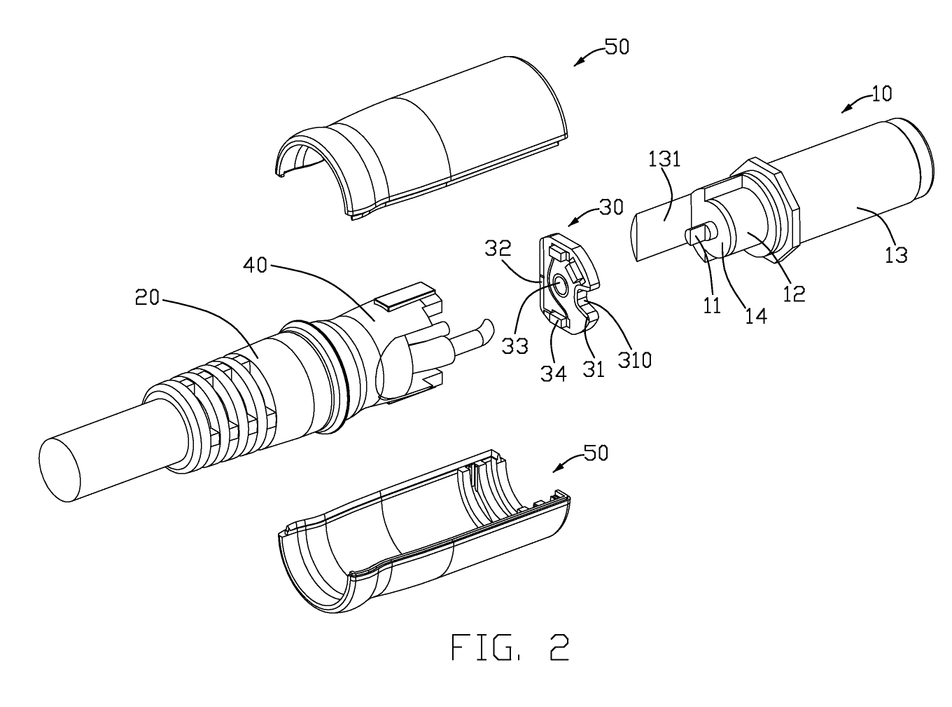

Reference to FIGS. 2-4, the power connector 100 has an internal printed circuit board 30 mounted to the mating plug 10 and located in one transverse direction perpendicular to the pluggable direction, and a plurality of light-emitting components 34 mounted to the internal printed circuit board 15 for indicating working status of the power connector 100. The internal printed circuit board 30 comprises a conductive region 300 having a first and a second conductive areas 31 and 32 disposed on opposite edges thereof and a central hole 33 defined through a center thereof for partially receiving the central pin 11 of the mating plug 10. The internal printed circuit board 30 has an opening 310 defined on one edge thereof, the first conductive area 31 is disposed around the opening 310. The protruding end 131 of the outer conductor 13 connects with the second conductive area 32 of the internal printed circuit board 30 and extends across the internal circuit board 30 for connecting with the cable 20.

The cable 20 has a second leg 21b electrically connected to the protruding end 131 for connecting to an anode signal, a first leg 21a connecting with the first conductive area 31 of the opening 152 and extending through the opening 152 of the internal printed circuit board 15 to electrically connect with the first terminal 12 of the mating plug 10 to connect to a cathode signal, and a third leg 21c connected to the central pin 11 for grounding purpose.

The guiding pipe 40 encloses the connecting section 24 of the cable 20 to transmit the light from the light-emitting component 34.

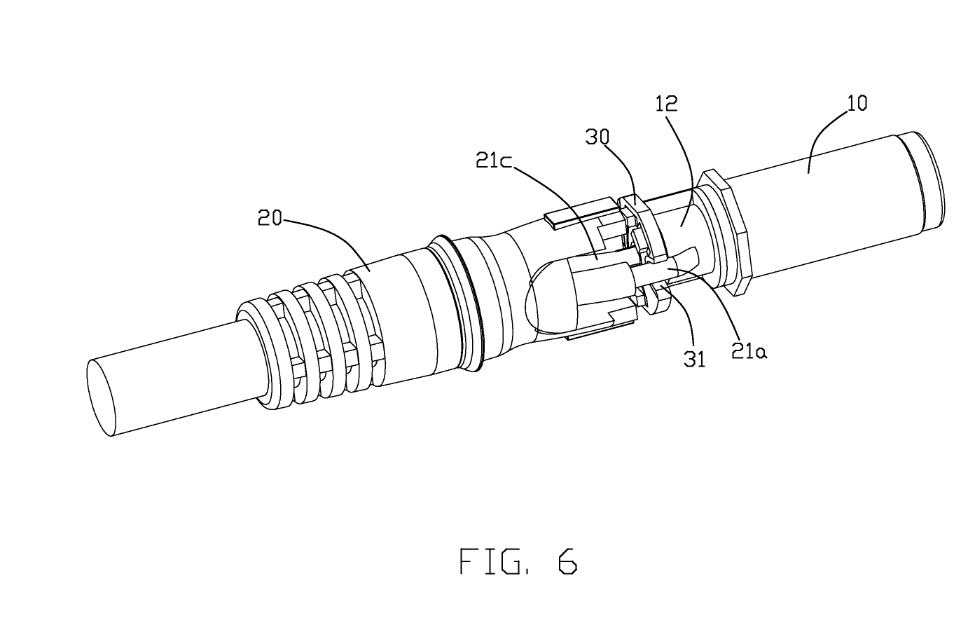

Reference to FIGS. 1-6, the method for assembling the power connector 100, comprising the steps of: (1) the internal printed circuit board 15 is mounted to the mating plug 10, the central pin 11 extending through the central hole 33 of the internal printed circuit board 15; (2) The protruding end 131 of the outer conductor 13 connects with the second conductive area 32 of the internal printed circuit board 30 and extends across the internal circuit board 30 for connecting with the second leg 21b of the cable 2; the first leg 21a is connected with the first conductive area 31 of the opening 152 and extending through the opening 152 of the internal printed circuit board 15 to electrically connect with the first terminal 12 of the mating plug 10; the third leg 21c is connected to the central pin 11 for grounding purpose; (3) The guiding pipe 40 encloses the cables 30; (4) the mating plug 10 and the guiding pipe 40 are enclosed in the outer barrel 50.

It is easy to connect the cable 20 to the mating plug 10 by the conductive areas 31, 32 disposed on the internal printed circuit board 15.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power connector pluggable with a complementary connector in a pluggable direction, comprising:
a mating plug having a plurality of contacts;
an internal printed circuit board mounted to the mating plug and located in one transverse direction perpendicular to the pluggable direction, the internal printed circuit board defining a conductive region;
at least one cable provided with a connecting section connecting with the conductive region of the internal printed circuit board and extending through the internal printed circuit board to connect with the contacts of the mating plug.

2. The power connector as claimed in claim 1, wherein said conductive region has a first and a second conductive areas disposed thereon, wherein said contacts of the mating plug have an outer conductor connected with the second conductive area and extending through the internal circuit board to electrically connect with the cable.

3. The power connector as claimed in claim 2, wherein said contacts of the mating plug have a first terminal, wherein the connecting section of the cable has a first leg electrically connected to the first conductive area and exposed from the internal printed circuit board to connect with the first terminal of the mating plug.

4. The power connector as claimed in claim 2, wherein said internal printed circuit board has an opening defined on one edge thereof, and the first conductive area is disposed around the opening.

5. The power connector as claimed in claim 2, wherein said cable has a second leg connected with the outer conductor.

6. The power connector as claimed in claim 1, wherein said mating plug has an insulator, wherein said contacts of the mating plug has a central pin embedded in the insulator, said cable has a third leg connected to the central pin.

7. The power connector as claimed in claim 6, wherein said internal printed circuit board has a central hole defined therethrough, the central pin extending through the central hole for connecting with the cable.

8. The power connector as claimed in claim 1, further comprising a light-emitting component mounted to the internal printed circuit board for indicating working status of the power connector, and a guiding pipe to transmit the light from the light-emitting component.

9. The power connector as claimed in claim 1, further comprising an outer barrel enclosing the mating plug and the cable.

10. A power connector pluggable with a complementary connector in a pluggable direction, comprising:
a mating plug having a plurality of contacts;
an internal printed circuit board mounted to the mating plug and located in one transverse direction perpendicular to the pluggable direction, the internal printed circuit board defining a conductive region;
at least one cable provided with a connecting section electrically connecting with the internal printed circuit board;
wherein said contacts of the mating plug connecting with the conductive region of the internal printed circuit board and extending through the internal printed circuit board to connect with the cable.

11. The power connector as claimed in claim 10, wherein said conductive region has a first and a second conductive areas disposed thereon, and wherein said contacts of the mating plug has an outer conductor connected with the second conductive area and extending through the internal circuit board to electrically connect with the cable.

12. The power connector as claimed in claim 11, wherein said contacts of the mating plug has a first terminal and a central pin, and wherein the cable has a first leg connected with the first conductive area and extending through the internal circuit board to electrically connect with the first terminal of the mating plug.

13. The power connector as claimed in claim 12, wherein said cable has a second leg electrically connecting with the outer conductor of the mating plug, and a third leg connected to the central pin.

14. A power connector comprising:
a mating plug having at least a first contact and a second contact coaxially arranged with each other;
an internal printed circuit board positioned behind the mating plug, said printed circuit board defining at least a first through hole and a second through hole; and
a cable including a first conductor and a second conductor; wherein
the first contact extends through the first hole and connected to the first conductor on a rear side of the printed circuit while the second conductor extends through the second through hole and connected to the second contact on the front side of the printed circuit board.

15. The power connector as claimed in claim 14, wherein the first contact is located at a center while the second contact is located on a periphery.

16. The power connector as claimed in claim 14, wherein said second through hole is essentially a through notch communicating with an exterior laterally other than axially.

17. The power connector as claimed in claim 14, further including a third contact extending beside the printed circuit board and from the front side of the printed circuit board to the rear side of the printed circuit board.

18. The power connector as claimed in claim 17, wherein said third contact abuts against a side edge of the printed circuit board.
